(19) United States
(12) Patent Application Publication
(10) Pub. No.: US 2005/0107560 A1
(43) Pub. Date: May 19, 2005

(54) Injection molded articles

(76) Inventor: Carlos Alberto Mota, Ontario (CA)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/715,065

(22) Filed: Nov. 17, 2003

(51) Int. Cl. C08F 10/14

(52) U.S. Cl. 526/348.5; 526/351

(57) ABSTRACT

The invention relates to linear low density polyethylene from single-site metallocene catalysts (mLLDPE), particularly suitable for injection molded articles having superior performance in cold temperature applications such as food storage containers. The mLLDPE is a copolymer comprising ethylene and hexene, and may be characterized by an MI of about 20 to 30 dg/min, most preferably about 25 dg/min, a density of about 0.915 to about 0.922, most preferably about 0.921 gm/cc, MFR<20 and more preferably about 16 to 17, Mw/Mn<3 and more preferably 2.5-3.0, Mz/Mw<2 and more preferably about 1.7 to 1.8, and a low amount of hexane (C6) extractables.

### FIELD OF THE INVENTION

The invention relates to injection molded articles having superior performance in cold temperature applications such as food storage containers.

### BACKGROUND OF THE INVENTION

Flexible sealed containers for household use such as the storage, refrigeration, or freezing of foods are typically formed by injection molding processes using linear low density polyethylene (LLDPE) produced using Zielger-Natta (Z/N) catalysts. Linear low density polyethylene (hereinafter “LLDPE”) is a term typically applied in the art to polyethylene homopolymers and copolymers in the density range of about 0.915 to about 0.940 g/cm³, which is linear and does not contain large quantities of long chain branching. LLDPE can be produced with conventional Ziegler-Natta catalysts (“ZIN catalysts”) or with metallocene catalysts. LLDPE produced using metallocene catalysts is often referred to as mLLDPE.

One problem associated with such articles made with Z/N catalyzed LLDPE is that they tend to have poor durability when used in refrigeration and repeated freeze/thaw cycles, resulting in tearing and cracking during use. Once torn or cracked the articles lose their sealing characteristics essential for food storage.

Yet another problem with most conventional grades of LLDPE is that the production rates are low because of limiting factors such as “stickiness” in the reactor walls, product discharge systems, and conveying pipelines. This stickiness is attributed to higher dissolved comonomer and lower onset melting points contributed by low molecular weight polyethylene oligomers.

The use of homogeneous metallocene (or single-site) catalysis to produce polyolefin resins has been discussed for many years. Such resins have been available since at least the early 1990's. It is known that lower extractables are one characteristic recognized in some mLLDPE films (typically measured in terms of percent polymer extracted), such as films made from Exact™ Resins, available from ExxonMobil Chemical Company, when compared with LLDPE resins made using Z/N catalysts. See, for instance, Plastics Technology, pp. 15-19, November 1991.

WO 01/96419 claims injection molded articles made with single site catalysts. The mLLDPE produced in the process according to the patent is said to be useful for injection molding of food packaging material, especially closures for food containers. These materials are said to exhibit low levels of migration, e.g., <5 mg/dm², and are further characterized by a Mw/Mn ranging from 2 to 60, preferably from 3 to 10, an MFR_{2.16} of 20 to 100, preferably 30 to 80, and by various other parameters. Cold temperature behavior is not discussed.

EP 0569249B1 and CA 2095702 teach an ethylene/alpha-olefin copolymer characterized by various parameters including a degree of branching, B, per 1,000 carbon atoms, which is defined by an equation set forth in the specification. The patents taken together cover a density range of 0.880 to 0.940.

U.S. Pat. No. 6,159,617 (see also CA 2173005) teaches ethylene polymers attractive for use in food packaging. The copolymers described therein are characterized by having a Polydispersity Index (Mw/Mn) of about 2-4, Crystallizable Chain Length Distribution Index of about 1-9, and by various other parameters, which are produced using unsupported metallocene catalysts. Again, cold temperature behavior is not discussed.

U.S. Pat. No. 6,552,138 is directed to an ethylene/alpha-olefin copolymer having a narrow molecular weight distribution Mw/Mn from 1.5 to 3.5, said to be suitable for flexible sealed containers

The present inventor has surprisingly discovered a metallocene-catalyzed LLDPE resin, containing much lower extractables at the same MI and density when compared with corresponding Z/N LLDPE, useful for the injection molding of articles having superior functionality and durability of repeat use in freeze/thaw cycles.

### SUMMARY OF THE INVENTION

The invention is directed to injection molded articles comprising an LLDPE resin produced using a single site catalyst (i.e., mLLDPE), said resin being a copolymer of ethylene and hexene, with 1-hexene preferably present from about 8 to 13 wt. % (2.8 to 4.7 mol %), characterized by an MI of about 22 to about 28 dg/min, more preferably about 24 to about 26 dg/min (ASTM D-1238, 190° C., 2.16 kg), a density of about 0.915 to about 0.918 g/cc, more preferably about 0.917 to about 0.918 g/cc (ASTM D-1505), an MFR<20 dg/min and more preferably about 16 to 17 dg/min (ASTM D-1238, Condition L), a molecular weight distribution Mw/Mn<3 and more preferably about 2.5-3.0, an Mz/Mw<2 and more preferably about 1.7 to 1.8, and a low amount of extractables, preferably <3 wt. % C₆ extractables.

These and other objects, features, and advantages will become apparent as reference is made to the following detailed description, preferred embodiments, examples, and appended claims.

### DETAILED DESCRIPTION

According to the invention, an injection molded article is provided comprising an MLLDPE resin, said mLLDPE resin being a copolymer of ethylene and hexene, with 1-hexene preferably present from about 8 to 13 wt. % (2.8 to 4.7 mol %).

The mLLDPE copolymer resin is further characterized by an MI (Melt Index) of about 22 to about 28 dg/min, more preferably about 24 to about 26 dg/min. When the MI of the mLLDPE copolymer resin is referred to herein, the MI is measured according to ASTM D-1238, 190° C., 2.1 kg.

The mLLDPE copolymer resin is further characterized by a density of about 0.915 to about 0.919 g/cc, more preferably about 0.917 to about 0.919 g/cc. When density of the mLLDPE copolymer resin is referred to herein, it is measured according to ASTM D-1505.

The mLLDPE copolymer resin is further characterized by an MFR (Melt Flow Ratio) of less than 20 dg/min (MFR<20 dg/min) and more preferably about 16 to 17 dg/min. When the MFR of the mLLDPE copolymer resin is referred to herein, it is measured according to ASTM D-1238, Condition L.

The mLLDPE copolymer resin is further characterized by a molecular weight distribution Mw/Mn<3 and more preferably about 2.5-3.0, and an Mz/Mw<2 and more preferably about 1.7 to 1.8. These are well-known parameters in the art, and one of ordinary skill in the art can determine their values.

The ratio Mw/Mn is the ratio of the weight average molecular weight (Mw) to the number average molecular weight (Mn), also referred to as MWD or polydispersity index, and can be measured directly by gel permeation chromatography techniques, or indirectly, by measuring the ratio of 1₂₁ to 1₂ as described in ASTM D-1238-F and ASTM D-1238-E respectively. I₂ is well known in the art as equivalent to Melt Index (MI). I₂₁ is also known as high load melt index (HLMI). Those skilled in the art will appreciate that there are several methods for determining MWD of a polymer sample. For the purposes of the present invention the molecular weight distribution of a polymer can be determined with a Waters Gel Permeation Chromatograph equipped with Ultrastyrogel columns and a refractive index detector. In this development, the operating temperature of the instrument was set at 145° C., the eluting solvent was trichlorobenzene, and the calibration standards included sixteen polystyrenes of precisely known molecular weight, ranging from a molecular weight of 500 to a molecular weight of 5.2 million, and a polyethylene standard, NBS 1475.

The “z-average molecular weight” Mz can be measured by high temperature gel permeation chromatography (GPC) using 1,2,4-trichlorobenzene as a carrier solvent, and Shodex AT-80 M/S (produced and sold by Showa Denko K.K., Japan) can be used as a column. The measurement is done under the following conditions: solution temperature of 140° C., solution concentration of 0.2% (w/v), and solvent flow rate of 1 ml/min.

The mLLDPE copolymer resin is further characterized by a low amount of extractables, preferably <3% C₆ extractables. Hexane (C₆) extractables is determined with a Soxtec extractor on samples milled to 20-mesh. Each sample is weighed, extracted with hexane at reflux conditions for one hour, rinsed for two hours, dried and reweighed. Weight percent hexane extractables is calculated from weight loss.

The resin used in the present invention can be produced using a single-site metallocene catalyst, preferably silica-supported, in a gas phase fluidized bed polymerization process, such as disclosed in U.S. Pat. Nos. 6,245,868 or 6,136,930. In a preferred embodiment the resin is LLM-103™ available from ExxonMobil Chemical Company, Baytown, Tex.

Injection molded articles made using the mLLDPE according to the present invention have superior taste and odor properties, superior performance in cold temperature applications, exhibit more flexibility in frozen food saver lids for improved ergonomics and ease of opening. Such articles also exhibit improved resistance to tear during repeat opening and closing of lids in frozen food storage. In addition, container lids made from such products offer more efficient sealing characteristics on containers molded with HDPE or polypropylene for effective liquid containment. It is preferred that the injection molded article according to the present invention have a Tensile Impact @ −40 C of at least about 300 ft.lb./in², more preferably about 340 ft.lb./in².

In certain embodiments the articles according to the present invention may comprise blends including one or more mLLDPEs as described herein, e.g., one or more copolymers of ethylene and 1-hexene, and also including mLLDPEs containing an alpha olefin other than 1-hexene, such as 1-butene, 1-pentene, 4-methyl-1-pentene, or 1-octene. However, in a preferred embodiment the articles will not contain one or more of the following (either as blends or copolymers): polypropylene, rubbers, EPDM or norbomene, copolymers having special pendant groups such as amino-type groups, copolymers of an iso-alkene such as iso-hexene, copolymers of pentene, and copolymers involving a diene monomer. Articles having layers, including laminate articles, are envisioned as embodiments, as are articles not having such layers.

In a preferred embodiment the composition according to the present invention comprises the MLLDPE according to the invention and high pressure low density polyethylene. In a more preferred embodiment there are only these two compositions in the blend; there is no third component. Thus, in an embodiment, an article according to the invention is an injection molded article consisting essentially of one or more mLLDPE ethylene and 1-hexene copolymers and high pressure low density polyethylene. In an embodiment there is no more than about 20 wt. % of the second component, preferably no more than about 15 wt. % , which is high pressure, low density polyethylene, the remainder being the mLLDPE ethylene and 1-hexene copolymer according to the present invention, preferably in the amount of at least about 80 wt. %, preferably at least about 85 wt. %, and optionally a third component. In another embodiment the blend consists essentially of about 80 to about 99 wt. %, most preferably about 85 wt. % mLLDPE ethylene and 1-hexene copolymer according to the present invention and about 1 to about 20 wt. %, most preferably about 15 wt. % high pressure low density polyethylene; other components may be added which do not affect the novel characteristics of the present invention. In another embodiment the blend consists only of about 85 wt. % mLLDPE ethylene and 1-hexene copolymer according to the invention and about 15 wt. % high pressure low density polyethylene.

In other preferred embodiment, which may be combined with the limitations of other embodiments and preferred embodiments described herein, there are no special additives such as redox indicators, peroxides (curing agent), pigments, inorganic fibers, blowing or foaming agents, waxes, slip agents, blocking agents, or any filler; there is no rubber or elastomer component; the blend is not a curable composition or cross-linkable compositions and does not contain curing or cross-linking agents; there is no vulcanized or vulcanizable polyolefin; the blend is not in the form of a suspension, solution or gel; the product or blend is not foamed; the components of the blend are not ionomers (having charged pendant groups, for example); the monomers which go to form the polymers are not branched; the blend is not a coating composition nor an adhesive composition.

### EXAMPLE

LLM-103™ resin having an MI=25 dg/min and a density of 0.917 g/cc, available from ExxonMobil Chemical Company, Baytown, Tex., is used to injection mold a kitchenware article including a container and a lid, useful for holding food items for cold storage. Tensile Impact @−40° C. is measured to be about 360 ft-lb/in² (ASTM-1822), and otherwise meeting the requirements of the present invention as set forth above in the summary of the invention.

The resin according to the present invention is particularly useful in injection molded articles. Articles made from the resin according to the present invention exhibit superior performance in cold temperature applications, more flexibility in frozen food save lids for improved ergonomics and ease of opening, improved resistance to tear during repeat opening and closing of lids in frozen food storage. In addition, container lids made from such products offer more efficient sealing characteristics on containers molded with high density polyethylene (HDPE) or polypropylene for effective liquid containment. Furthermore, the resin can be produced at higher rates in gas-phase reactors at least in part because the particle size is typically larger and less “sticky”.

Preferred articles include: (A) an injection molded article, said article comprising an MLLDPE copolymer resin of ethylene and hexene, said resin further characterized by an MI of about 22 to about 28 dg/min, a density of about 0.915 to about 0.919 g/cc, an MFR<20 dg/min, an Mw/Mn<3, an Mz/Mw<2, and <3% C₆ extractables; and more preferred embodiments including one or more of the following: wherein said copolymer resin comprises from about 8 to about 13 wt. % 1-hexene, wherein said copolymer resin is further characterized by an MI of about 24 to about 26 dg/min, wherein said copolymer resin is further characterized by a density of about 0.917 to about 0.919 g/cc, wherein said copolymer resin is further characterized by an MFR of from about 16 to about 17 dg/min, wherein said copolymer resin is further characterized by a molecular weight distribution Mw/Mn in the range of about 2.5 to about 3.0, wherein said copolymer resin further is characterized by an Mz/Mw in the range of about 1.7 to about 1.8, wherein the article is further characterized by having a Tensile Impact @ −40 C of at least about 340 ft.-lb./in², wherein said copolymer resin is further comprised of about 1 to about 20 wt. % of a high pressure, low density polyethylene, and also wherein said copolymer resin consists essentially of about 99 to about 80 wt. % of said niLLDPE copolymer of ethylene and hexene and about 1 to about 20 wt. % of a high pressure, low density polyethylene; (B) an injection molded article comprising a container and a lid for said container, wherein said container comprises a resin selected from HDPE, polypropylene, and mixtures thereof, and said lid comprises an niLLDPE copolymer resin of ethylene and hexene, said resin further characterized by an MI of about 22 to about 28 dg/min, a density of about 0.915 to about 0.919 g/cc, an MFR<20 dg/min, an Mw/Mn<3, an Mz/Mw<2, and <3% C₆ extractables; and also one or more of the following preferred embodiments: wherein said copolymer resin of said lid comprises from about 8 to about 13 wt. % 1-hexene, wherein said copolymer resin of said lid is further characterized by an MI of about 24 to about 26 dg/min, wherein said copolymer resin of said lid is further characterized by a density of about 0.917 to about 0.919 g/cc, wherein said copolymer resin of said lid is further characterized by an MFR of from about 16 to about 17 dg/min, wherein said copolymer resin of said lid is further characterized by a molecular weight distribution Mw/Mn in the range of about 2.5 to about 3.0, wherein said copolymer resin of said lid is further characterized by an Mz/Mw in the range of about 1.7 to about 1.8, wherein said lid is further characterized by having a Tensile Impact @ −40 C of at least about 340 ft.-lb./in², wherein said copolymer resin of said lid further comprising about 1 to about 20 wt. % of a high pressure, low density polyethylene, and also wherein said copolymer resin of said lid consisting essentially of about 99 to about 80 wt. % of said mLLDPE copolymer of ethylene and hexene and about 1 to about 20 wt. % of a high pressure, low density polyethylene. Additional preferred embodiments of the present invention include the use of any of the aforementioned embodiments (alone or in combination as would be readily appreciated by one of skill in the art) in frozen food storage and/or under repeated freeze/thaw cycles.

Trade names used herein are indicated by a ™ symbol or ® symbol, indicating that the names may be protected by certain trademark rights, e.g., they may be registered trademarks in various jurisdictions.

All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted. When numerical lower limits and numerical upper limits are listed herein, ranges from any lower limit to any upper limit are contemplated.

While the illustrative embodiments of the invention have been described with particularity, it will be understood that various other modifications will be apparent to and can be readily made by those skilled in the art without departing from the spirit and scope of the invention. Many variations will suggest themselves to those skilled in this art in light of the above detailed description. All such obvious variations are within the full intended scope of the appended claims.

1. An injection molded article, said article comprising an mLLDPE copolymer resin of ethylene and hexene, said resin further characterized by an MI of about 22 to about 28 dg/min, a density of about 0.915 to about 0.919 g/cc, an MFR<20 dg/min, an Mw/Mn<3, an Mz/Mw<2, and <3% C₆ extractables.

2. The injection molded article according to claim 1, said copolymer resin comprising from about 8 to about 13 wt. % 1-hexene.

3. The injection molded article according to claim 1, said copolymer resin further characterized by an MI of about 24 to about 26 dg/min.

4. The injection molded article according to claim 1, said copolymer resin further characterized by a density of about 0.917 to about 0.919 g/cc.

5. The injection molded article according to claim 1, said copolymer resin further characterized by an MFR of from about 16 to about 17 dg/min.

6. The injection molded article according to claim 1, said copolymer resin further characterized by a molecular weight distribution Mw/Mn in the range of about 2.5 to about 3.0.

7. The injection molded article according to claim 1, said copolymer resin further characterized by an Mz/Mw in the range of about 1.7 to about 1.8.

8. The injection molded article according to claim 1, wherein said article further characterized by having a Tensile Impact @ −40 C of at least about 340 ft.-lb./in².

9. The injection molded article according to claim 1, said copolymer resin further comprising about 1to about 20 wt. % of a high pressure, low density polyethylene.

10. The injection molded article according to claim 1, said copolymer resin consisting essentially of about 99 to about 80 wt. % of said MLLDPE copolymer of ethylene and hexene and about 1 to about 20 wt. % of a high pressure, low density polyethylene.

11. An injection molded article comprising a container and a lid for said container, wherein said container comprises a resin selected from HDPE, polypropylene, and mixtures thereof, and said lid comprises an mLLDPE copolymer resin of ethylene and hexene, said resin further characterized by an MI of about 22 to about 28 dg/min, a density of about 0.915 to about 0.919 g/cc, an MFR<20 dg/min, an Mw/Mn<3, an Mz/Mw<2, and <3% C₆ extractables.

12. The injection molded article according to claim 11, said copolymer resin of said lid comprising from about 8 to about 13 wt. % 1-hexene.

13. The injection molded article according to claim 11, said copolymer resin of said lid further characterized by an MI of about 24 to about 26 dg/min.

14. The injection molded article according to claim 11, said copolymer resin of said lid further characterized by a density of about 0.917 to about 0.919 g/cc.

15. The injection molded article according to claim 11, said copolymer resin of said lid further characterized by an MFR of from about 16 to about 17 dg/min.

16. The injection molded article according to claim 11, said copolymer resin of said lid further characterized by a molecular weight distribution Mw/Mn in the range of about 2.5 to about 3.0.

17. The injection molded article according to claim 11, said copolymer resin of said lid further characterized by an Mz/Mw in the range of about 1.7 to about 1.8.

18. The injection molded article according to claim 11, wherein said lid is further characterized by having a Tensile Impact @ −40 C of at least about 340 ft.-lb./in².

19. The injection molded article according to claim 11, said copolymer resin of said lid further comprising about 1 to about 20 wt. % of a high pressure, low density polyethylene.

20. The injection molded article according to claim 11, said copolymer resin of said lid consisting essentially of about 99 to about 80 wt. % of said mLLDPE copolymer of ethylene and hexene and about 1 to about 20 wt. % of a high pressure, low density polyethylene.

21. In a method of storing food subjected to repeated freeze/thaw cycles, the improvement comprising storing food in an article according to claim 1, said article comprising a container and a lid.

22. In a method of storing food subjected to repeated freeze/thaw cycles, the improvement comprising storing food in an article according to claim 11, said article comprising a container and a lid.
